(19) United States
(12) Patent Application Publication
(10) Pub. No.: US 2004/0255003 A1
(43) Pub. Date: Dec. 16, 2004

(54) System and method for reordering the download priority of markup language objects

(76) Inventors: Kirk S. Tecu, Greeley, CO (US); W. Robert Haas, Fort Collins, CO (US); Wade Weitzel, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/462,401

(22) Filed: Jun. 16, 2003

(51) Int. Cl. G06F 15/16

(52) U.S. Cl. 709/217

(57) ABSTRACT

A method and system is provided for reordering the download priority of markup language objects. The method includes the operation of sending a request for a markup language page from a client computer on a network to a server on the network. The operation of transmitting a page layout from the server to the client computer is performed in response to the request for a markup language page. The page layout description has placeholders that are associated with markup language objects in the markup language page. According to another operation of the present invention a user can select at least one placeholder from the page layout description that is displayed to the user. Also included is the operation of reordering the download priority of the markup language objects according to at least one placeholder selected by the user.

### FIELD OF THE INVENTION

The present invention relates generally to markup language objects.

### BACKGROUND

Computer networks enable the transfer of digital information from one computer to another computer. Such networks can include local area networks, wide area networks, the Internet and other networking schemes. One common network service that uses the Internet to exchange information is known as the World Wide Web. Documents, information, and digital objects on the World Wide Web can be saved on servers that store and disseminate Hypertext Markup Language (HTML) pages upon a user's request. The user on a client computer can then access the HTML pages with software called a browser. HTML pages use a set of labels that are embedded within text to control formatting, page linking, and distinguishing individual elements or groups of elements for display or identification purposes. The labels are typically known as “tags.”

HTML is just one member of a family of markup languages used to create electronic documents or network pages. The fundamental markup language page format is generally a text document embedded with tags that provide the formatting of the page as well as the hypertext links. Standard Generalized Markup Language (SGML) is considered the foundation markup language from which HTML, Extensible Markup Language (XML), Extensible Hypertext Markup Language (XHTML) and other markup languages are derived. Markup language pages can be formatted to contain markup language objects such as text, graphics, animations, videos, audio, hypertext links and other digital information. Markup language pages can also include Common Gateway Interface (CGI) scripts, Java applets, and other programs that help define page content.

Markup language pages and objects are frequently accessed by using the HTTP protocol to negotiate a connection between a client computer and a server computer, download page content information, and then download all other objects of that page in order. The browser generally determines the download order of the objects after it has received the page information from the server. As the components are downloaded to the browser, it places them on the page in the appropriate position as specified by the page layout information.

When the components begin to download, the user may see a text description appear for an object that has not yet been downloaded. In addition, the page layout data that the browser has already received and processed can display a placeholder for the object. The user may be most interested in accessing this specific object, and no other content. The user may also desire to access a particular object before accessing or viewing other objects. With current technology, the object of interest may be the next to be downloaded, or it may be the last. Depending on the content of the markup language page, there could be a significant delay before the object of interest is downloaded.

In the past, downloading schemes have been created that attempt to expedite the transfer of digital information in a network. In one such scheme, network latency can be used to determine the download order of markup language objects. The download order can be determined by the server and can be based on an algorithm that is predefined by an author. While this may appear to improve performance, it does not avoid the delay that may exist before an object of interest is downloaded.

### SUMMARY OF THE INVENTION

The present invention provides a system and method for reordering the download priority of markup language objects. The method includes the operation of sending a request for a markup language page from a client computer on a network to a server on the network. The operation of transmitting a page layout from the server to the client computer is performed in response to the request for a markup language page. The page layout description has placeholders that are associated with markup language objects in the markup language page. According to another operation of the present invention a user can select at least one placeholder from the page layout description that is displayed to the user. Also included in the present invention is the operation of reordering the download priority of the markup language objects according to at least one placeholder selected by the user.

### BRIEF DESCRIPTION OF THE DRAWINGS

FIG. 1 is a flow chart illustrating a method for reordering the download priority of markup language objects according to an embodiment of the present invention;

FIG. 2 is a flow chart illustrating a method for automating the reordering of the download priority of markup language objects using a download priority file according to another embodiment of the present invention;

FIG. 3 is a block diagram illustrating an embodiment of the invention for reordering download priority;

FIG. 4 is a block diagram illustrating an embodiment of the present invention for automating the reordering of the download priority of markup language objects using a download priority order file;

FIG. 5 is a block diagram of a markup language page according to an embodiment of the present invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

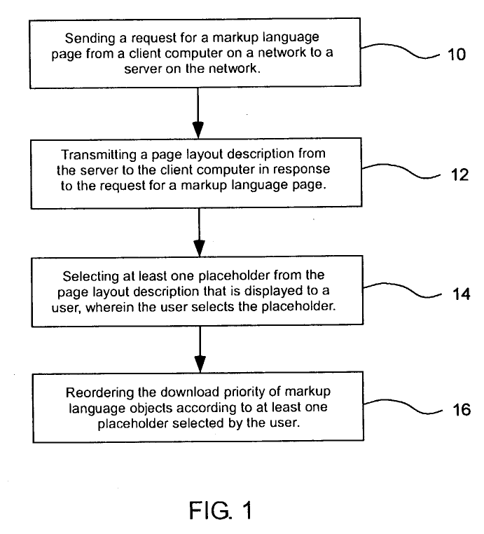

The present invention provides a system and method for prioritizing the download order of markup language objects. FIG. 1 illustrates that the invention includes the operation of sending a request for a markup language page from a client computer on a network to a server on the network in block 10. The request is made when a user directs the client computer to send the request. This can be done when the user clicks on a link, types in a web page address or performs any other action that directs a client computer to request a markup language page over a network.

Next, the server transmits a page layout description to the client computer in response to the request for a markup language page, as shown in block 12. The page layout description maps markup language objects to positions in the markup language page and has placeholders that are associated with markup language objects in the markup language page. The browser of the client computer can display the page layout description in a grid or tabular type of format. The transmittal of the page layout description occurs before any of the markup language objects are transmitted, and the page layout description usually transfers much faster than the markup language objects because the page layout description is usually small in size compared to the markup language objects. The operation shown in block 14 describes that the user can then select at least one placeholder from the page layout description that is displayed to a user. According to one embodiment of the present invention, the user selects a placeholder with a mouse pointer. The user can also select a placeholder using a keyboard shortcut, the tab key, or any other user-driven selection method utilized by a client computer. After one or more objects are selected, the task of reordering the download priority of markup language objects according to at least one placeholder selected by the user is performed in block 16.

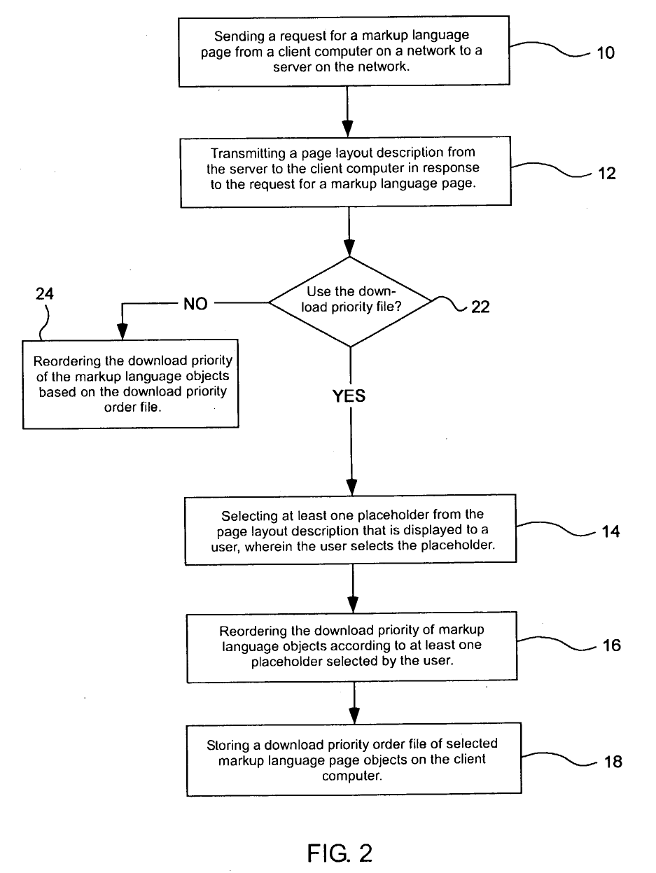

In another embodiment of the present invention, the client computer records the selections made by the user. This embodiment is useful if a user plans to download a markup language page more than once. As illustrated in FIG. 2, operations 10, 12, 14 and 16 are the same as the operations discussed in FIG. 1. However, following the reordering operation in block 16, block 18 of FIG. 2 illustrates the operation of storing a download priority order file of selected markup language page objects on the client computer. At some later time, the user can send a subsequent request for the same markup language page from the client computer to the server. After the request is sent and the server begins transmitting a page layout description, a reprioritization module can recognize that the markup language page has been visited before and query the user as to whether or not the download priority file should be used, as in block 22. This query can be in a pop-up box, a preset option, or any other method used to query a user. In another embodiment of the present invention the reprioritization module automatically uses the download priority file instead of querying the user.

If the user selects not to use the download priority file, the method proceeds as previously explained with the selecting operation 14, the reordering operation 16 and storing operation 18. If the choice is made to use the download priority file, the operation described in block 24 is performed and the download priority of the markup language objects is reordered based on the information stored in the download priority order file. This saves the user the time involved in selecting placeholders every time a markup language page is visited.

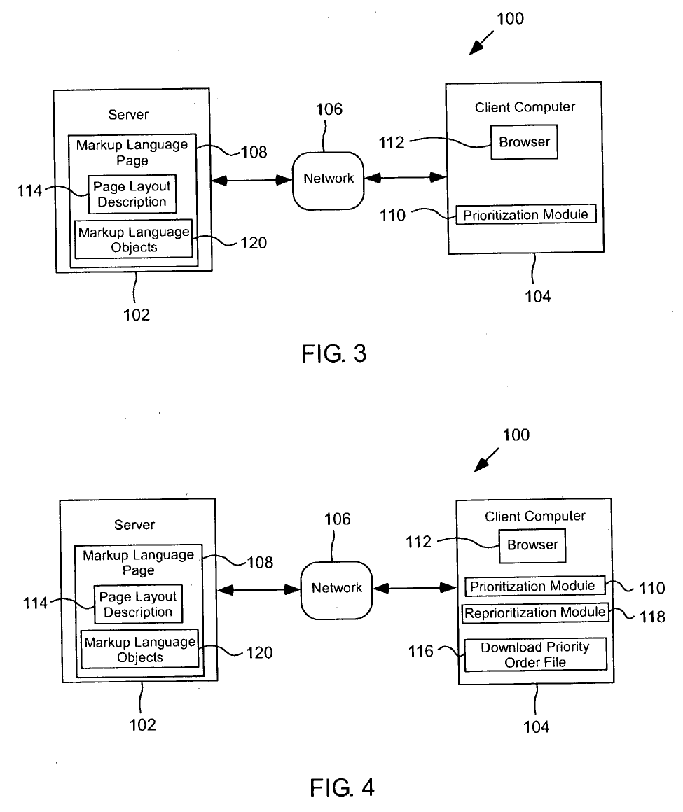

As illustrated in FIG. 3, one embodiment of the present invention provides a system 100 for prioritizing a download order of markup language objects 120 transmitted to a client computer 104 over a network 106. The client computer can be a user's workstation, a portable computer or another networkable device, and the network 106 can be the Internet, a local area network, a wide area network, or any other system that connects multiple computers. The system also includes a server 102 connected to the client computer over the network. This server is any computer system that serves as a central repository of data and programs shared by users on a network. In the present invention, the server stores at least one markup language page 108 that includes markup language objects 120 with a page layout description 114.

A browser 112 can be stored on the client computer 104. The browser is a program that serves as an access interface to the network 106 and allows a user to view markup language pages. The browser can be Microsoft Explorer, Netscape Navigator, a microbrowser or another of the myriad of browsers available to a user. The user commands the browser to send requests for information over the network. The client computer 104 also stores a prioritization module 110 that directs the browser to prioritize a download order of the markup language objects 120 based on a user selection.

The prioritization module 110 can direct the browser 112 to prioritize the download order of markup language objects 120 based on the selection or selections made by the user. Reordering can be accomplished in many ways. According to one embodiment of the present invention, the user selects one of three different reordering options in the prioritization module 110. With one option, the highest download priority is given to the markup language object associated with the most recently selected placeholder. In another option, the lowest download priority is given to the markup language object associated with the most recently selected placeholder. Selecting a markup language object to be downloaded last can be useful if the user is not interested in downloading a large markup language object until the user has viewed the remainder of the markup language page.

The user also has the option of reordering the download priorities according to multiple selections. The assignments of download priorities to the multiple markup language objects 120 can be based on an order in which the placeholders associated with the markup language objects 120 are selected by the user. As previously mentioned, the user can make a selection with a mouse, a keyboard shortcut, the tab key, or any other user-driven selection method utilized by a computer.

In an alternative embodiment depicted in FIG. 4, the client computer also includes a reprioritization module 118. The reprioritization module saves prioritization information in a download priority order file 116 on the client computer 104. If a markup language page 108 is visited more than once, the reprioritization module can be used to prioritize a download order of the markup language objects 120 based on the download priority order file. The prioritization module 110 and the reprioritization module can be combined to form a single module.

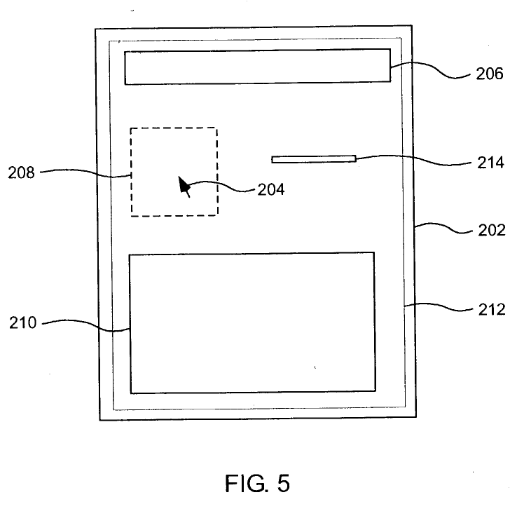

Following the operations described in FIG. 1, after a user makes a request for a markup language page 108 via the client computer 104, the browser 112 sends the request across the network 106 from the server 102. An example of a markup language page is illustrated in FIG. 5. The markup language page 202 has several different parts that are transmitted at different times. The server initially transmits the page layout description 212. The page layout description 212 includes placeholders 206, 208, 210, 214 that define where the downloaded objects are to be displayed. In one embodiment the placeholders will be defined by markup language tags, stylesheets or layout definitions.

In the page layout description 212, a placeholder may be displayed as a frame 206, 210, a text description 214 or some other image. After the placeholders 206, 208, 210, 214 are displayed to the user, the user can select one or more placeholders. The selection can be made by a mouse pointer 204 as illustrated, or by another method of selection as previously described.

The placeholders 206, 208, 210, 214 are associated with markup language objects in the markup language page and are used by the prioritization module to determine the download order of the markup language objects. Once a placeholder is selected 208, the prioritization module can reorder the download priority of the markup language objects based on the user selection and on a downloading scheme. This download scheme can be defined or selected by a user. The markup language objects can be images, Macromedia plug-ins, Flash objects, Active X objects, Java applets or any object known to those skilled in the art to be included in markup-language pages.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiment(s) of the invention. It will be apparent to those of ordinary skill in the art that numerous modifications can be made without departing from the principles and concepts of the invention as set forth in the claims.

1. A method for reordering a download priority of markup language objects, comprising the steps of:
sending a request for a markup language page from a client computer on a network to a server on the network;
transmitting a page layout description from the server to the client computer in response to the request for the markup language page, wherein the page layout description has placeholders that are associated with markup language objects in the markup language page;
selecting at least one placeholder from the page layout description that is displayed to a user, wherein the user selects the placeholder; and
reordering the download priority of markup language objects according to at least one placeholder selected by the user.

2. A method as in claim 1, further comprising the step of enabling the user to define a download scheme for reordering the download priority of markup language objects.

3. A method as in claim 1, wherein the step of selecting at least one placeholder further comprises the step of selecting a placeholder with a mouse pointer.

4. A method as in claim 1, wherein the step of selecting at least one placeholder further comprises the step of using a keyboard shortcut to select a placeholder.

5. A method as in claim 1, wherein the step of selecting at least one placeholder further comprises the step of using a tab key to select a placeholder.

6. A method as in claim 1, wherein the step of reordering the download priority of markup language objects further comprises the step of assigning a highest download priority to a markup language object associated with a selected placeholder.

7. A method as in claim 1, wherein the step of selecting at least one placeholder further comprises the step of selecting two or more placeholders.

8. A method as in claim 7, wherein the step of reordering the download priority of markup language objects further comprises the step of assigning download priorities to the markup language objects based on an order in which the placeholders associated with the markup language objects were selected.

9. A method as in claim 1, wherein the step of reordering the download priority of markup language objects further comprises the step of assigning a lowest download priority to a markup language object associated with a selected placeholder.

10. A system for prioritizing a download order of markup language objects received by a client computer over a network comprising:
a server connected to the client computer over the network;
a markup language page stored on the server, the markup language page including markup language objects;
a browser stored on the client computer and configured to request and receive the markup language page; and
a prioritization module on the client computer that directs the browser to prioritize the download order of the markup language objects in the markup language page based on a user selection.

11. A system as in claim 10, further comprising:
a download priority order file stored on the client computer and configured to store the download order of the markup language objects based on the user selection; and
a reprioritization module stored on the client computer that directs the browser to prioritize the download order of the markup language objects based on the download priority order file.

12. A system as in claim 10, further comprising:
a page layout description of the markup language page that is transferred from the server to the client computer, wherein the page layout description has placeholders that are associated with markup language objects in the markup language page.

13. A method for reordering the download priority of markup language page objects, comprising the steps of:
sending a request for a markup language page from a client computer on a network to a server on the network;
transmitting a page layout description from the server to the client computer in response to the request for the markup language page, wherein said page layout description has placeholders that are associated with markup language objects in the markup language page;
selecting at least one placeholder from the page layout description that is displayed to a user, wherein the user selects the placeholder;
reordering the download priority of selected markup language page objects according to a selection of the user; and
storing a download priority order file of selected markup language page objects on the client computer, wherein an order of the selected markup language page objects is stored based on the selection of the user.

14. A method as in claim 13, further comprising the step of enabling a user to define a download scheme for reordering the download priority of markup language objects.

15. A method as in claim 13, wherein the step of selecting at least one placeholder further comprises the step of selecting a placeholder using a mouse pointer, a keyboard shortcut, or a tab key.

16. A method as in claim 13, wherein the step of reordering the download priority of selected markup language page objects further comprises the step of assigning a highest download priority to a markup language object associated with a selected placeholder.

17. A method as in claim 13, wherein the step of selecting at least one placeholder further comprises the step of selecting two or more placeholders.

18. A method as in claim 17, wherein the step of reordering the download priority of selected markup language page objects further comprises the step of assigning download priorities to the markup language objects based on an order in which the placeholders associated with the markup language objects were selected.

19. A method as in claim 13, wherein the step of reordering the download priority of selected markup language page objects further comprises the step of assigning a lowest download priority to a markup language object associated with a selected placeholder.

20. A method as in claim 13, further comprising the steps of:
sending a subsequent request for a markup language page from the client computer to the server; and
determining whether to use the download priority order file to reorder the markup language objects;
reordering the download priority of the markup language objects based on the download priority order file when it is determined that the download priority order file will be used.

21. A method as in claim 20, wherein the step of determining whether to use the download priority order file further comprises the step of determining whether the download priority order file is available.

22. A method as in claim 21, further comprising the step of using the download priority order file when it is determined that the download priority file is available.

23. A method as in claim 21, further comprising the step of querying the user to determine whether to use the download priority order file.

24. A system for prioritizing a download order of markup language objects to a client computer over a network comprising:
a server means for transmitting a page layout description to the client computer, and the server means is connected to the client computer over the network;
a markup language page means stored on the server means, the markup language page means including markup language objects;
a browser means on the client computer for sending a request for a markup language page means from the client computer to the server means; and
a prioritization module means on the client computer for directing the browser means to prioritize a download order of the markup language objects in the markup language page means based on a user selection.

25. An article of manufacture, comprising:
a computer usable medium having computer readable program code embodied therein for reordering a download priority of markup language objects based on one or more selections made by a user;
computer readable program code for sending a request for a markup language page from a client computer on a network to a server on the network;
computer readable program code for transmitting a page layout description from the server to the client computer in response to the request for a markup language page, wherein the page layout description has placeholders that are associated with markup language objects in the markup language page;
computer readable program code for selecting at least one placeholder from the page layout description that is displayed to a user; and
computer readable program code for reordering the download priority of markup language objects according to at least one placeholder selected by the user.

26. An article of manufacture as in claim 25, further comprising:
computer readable program code for saving the download priority of markup objects to a download priority order file; and
computer readable program code for reordering the download priority of markup language page objects based on a download priority order file.
